(19) United States
(12) Patent Application Publication
(10) Pub. No.: US 2010/0012442 A1
(43) Pub. Date: Jan. 21, 2010

(54) HYSTERESIS CHARACTERIZING TYPED ELECTRO PEDAL DEVICE

(75) Inventors: Changhoe KOO, Incheon (KR); Inhwan LEE, Gyeonggi-do (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Seoul (KR)

(21) Appl. No.: 12/206,061

(22) Filed: Sep. 8, 2008

(30) Foreign Application Priority Data
Jul. 16, 2008 (KR) 10-2008-0068889

(51) Int. Cl. F16D 55/00

(52) U.S. Cl. 188/72.9

(57) ABSTRACT

According to the electro pedal of the present invention, a pedal simulator is achieved by a variable damper including a piston operating with an operation rod connected to a pedal and elastically supported by first and second springs having different elasticity, a piston flange having a flow channel, through which the oil passes, at the end of piston elastically supported by second spring in a chamber filled with the oil, and a rubber cup being in close contact with piston flange and changing the flow rate of oil while being elastically deformed by the hydraulic pressure according to the flow direction of the oil, such that hysteresis characteristics showing pedal effort without difference can be achieved, such as when hydraulic pressure is used, not only generating simple linear pedal effort and a damping force from a fixed damping coefficient in operation and return stroke of pedal.

### CROSS-REFERENCE TO RELATED APPLICATIONS

The present application is based on, and claims priority from, Korean Application Serial Number 10-2008-0068889, filed on Jul. 16, 2008, the disclosure of which is hereby incorporated by reference herein in its entirety.

### FIELD OF THE INVENTION

The present invention relates to an electro pedal device, particularly a hysteresis characterizing typed electro pedal device.

### BACKGROUND OF THE INVENTION

In general, a brake-by-wire system brakes a vehicle such that an electro caliper provided to each wheel receives a signal from an ECU (electric control unit) of electro brake and holds the disc of the wheel, without mechanical connection between a driver and a braking wheel.

The brake-by-wire system is provided with a specific device that can provide appropriate pedal feeling to the driver because it cannot achieve hysteresis according to a reaction force, which physically means loss of energy, in addition to pedal effort characteristics corresponding to pedal feeling that the driver can sense when operating a pedal of a hydraulic brake system that is mechanically connected, that is, non-linear pedal effort mainly caused by input/output characteristics (jump-in and boosting force, after an earlier section of load) generated by a booster.

For example, the system has both of a mechanic device that provides appropriate pedal feeling to a driver when the pedal is operated and an electric device that senses the driver's intention of operating the pedal, which is generally called ‘pedal simulator’.

The performance of the pedal simulator is determined by characterization of hysteresis showing the relationship between the pedal effort and the pedal travel when the pedal is released after operating, as compared with forming non-linear pedal effort caused by the input/output characteristics of a booster.

Considering the pedal feeling that is provided to the driver, the hysteresis characteristic of the pedal shows that the stroke of the brake pedal is not decreased even if the pedal effort applied to the brake pedal after the driver operates the pedal decreases, which is because the hysteresis shows the amount of pedal effort that can be removed without decreasing the stroke of the pedal.

Characterizing the hysteresis of the pedal by the pedal simulator is possible, for example, by a method using a pressure difference between a valve and a spring used, but this increases the cost and makes different pedal effort as compared with a hydraulic device.

### SUMMARY OF THE INVENTION

Embodiments of the present invention help overcome the drawbacks in the related art and it is an object of the invention to achieve a hysteresis characteristic that provide similar pedal effort without a difference, such as when hydraulic pressure is applied, by applying a damper, which changes oil flow in applying and releasing pedal effort to a pedal, to a pedal simulator of an electro pedal.

Further, it is another object of the invention to improve driving comfort and safety, in addition to reducing pedal effort in emergency braking and tiredness of a driver in continuous braking, without only generating simple linear pedal effort and a damping force from a fixed damping coefficient by using a damper that changes the oil flow according to operation of the pedal, in the pedal simulator of the electro pedal.

Further, it is another object of the invention to minimize the weight without using expensive parts increasing the manufacturing cost, such as MR fluid or electromagnet by achieving hysteresis characteristics without a difference while non-linearly changing the pedal effort using a damper changing the oil flow to the cylinder, in the pedal simulator of the electro pedal.

In order to achieve the objects of the invention, a hysteresis characterizing typed electro pedal device includes a pedal and a pedal simulator. The pedal is hinged at one end by a pedal member to be stamped by a driver. The pedal simulator changes a damping force by operation and return stroke of the pedal by allowing oil filled in a chamber to flow backward through a piston flange formed at one end of a piston connected to the pedal when the piston is pushed in the chamber of a housing by operation of the pedal, and by discharging the oil through the piston flange when the piston is pushed out of the chamber of the housing by return of the pedal and discharging the oil through a gap between a cup that is compressed by oil pressure and the inside of the chamber.

The simulator includes the housing, the piston, a sealing member, a pair of springs, and a variable damper. The housing has the chamber receiving the oil, which is liquid filler, therein, and is attached to a car body, behind the pedal. The piston moves forward/backward in the chamber by an operation rod fixed to the pedal. The sealing member maintains airtightness by closing an inlet of the chamber. The pair of springs generates pedal effort while being compressed when the piston is pushed back. The variable damper changes the damping force according to the movement direction of the piston by increasing the flow rate of the oil in the chamber when the piston comes out more the flow rate of the oil in the chamber when the piston is pushed back.

The variable damper includes the piston flange and an elastic cup. The piston flange coaxially expands at one end of the piston in the chamber of the housing and has a flow channel where the oil passes. The elastic cup is fitted around the piston flange to discharge the oil to the front while being compressed by pressure of the oil behind the piston flange when the piston passes through the chamber.

Further, the variable damper includes the piston flange and the rubber cup. The piston flange coaxially expands at one end of the piston disposed in the chamber of the housing and has a flow channel where the oil passes, at a position of which the diameter is larger than the diameter of the piston. The rubber cup has a flow channel corresponding to the flow channel of the piston flange when being fitted around the piston flange.

According to the invention, by using the pedal simulator equipped with a cylinder having a profile that non-linearly changes the pedal effort according to the pedal stroke of the electro pedal, it is possible to achieve hysteresis characteristics that provides pedal effort without a difference, such as when hydraulic pressure is used.

Further, since the pedal simulator of the electro pedal can non-linearly change the pedal effort, it is possible to achieve active hysteresis in emergency braking or continuous braking. Therefore, in addition to improving driving comfort and safety by improving the pedal operating force, it is possible to reduce the manufacturing cost caused by using expensive parts, such as MR fluid or an electromagnet, and achieve tuning of the cylinder of the pedal simulator on the basis of the driving conditions and drivers' characteristics.

### BRIEF DESCRIPTION OF THE DRAWINGS

For better understanding of the nature and objects of the present invention, reference should be made to the following detailed description with the accompanying drawings, in which:

FIG. 1 is a view showing the configuration of a hysteresis characterizing typed electro pedal device according to the invention;

FIGS. 2 and 3 are views illustrating the damper operation of the electro pedal device when a pedal is operated and released, according to the invention;

FIG. 4 is a view showing a damper modification of the electro pedal device according to the invention;

FIGS. 5A and 5B are views illustrating the damper operation of the electro pedal device of FIG. 4, when a pedal is operated and released; and

FIG. 6 is a diagram showing hysteresis of an electro pedal device according to the invention.

### DETAILED DESCRIPTION OF THE PREFERRED EMBODIMENTS

Embodiments of the invention are described hereafter in detail with reference to the accompanying drawings, but theses embodiments are just examples and can be achieved in various modifications by those skilled in the art. Therefore, the present invention is not limited to the embodiments.

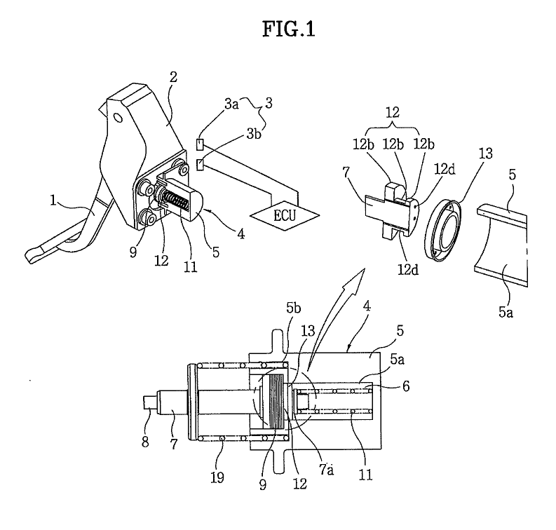

FIG. 1 shows the configuration of a hysteresis characterizing typed electro pedal device according to the invention, in which the hysteresis characterizing typed electro pedal device includes: a pedal 1 that is hinged at one end by a pedal member 2 to be stamped by a driver; a sensor 3 that detects and transmits the fact that pedal 1 is operated, to an ECU 20; and a pedal simulator 4 that has a housing 5 with a chamber 5a in which a piston 7 connected to pedal 1 changes the flow rate of oil filled therein while moving forward/backward in order not to only generate simple linear pedal effort and a damping force from a fixed damping coefficient in operation and return stroke of pedal 1.

Sensor 3 is composed of an angle sensor 3a that measures the amount of movement of pedal 1 operating and returning and a pressure sensor 3b that measures the amount of pedal effort applied to pedal 1.

Further, pedal simulator 4 includes: housing 5 that has chamber 5a receiving oil, which is liquid filler 6, therein, and is attached to the car body, behind pedal 1; piston 7 that moves forward/backward in chamber 5a by an operation rod 8 fixed to pedal 1; a sealing member 9 that maintains airtightness by closing the inlet of chamber 5a; a pair of springs that generates pedal effort while being compressed when piston 7 is pushed back; and a variable damper that changes the damping force generated according to the movement direction of piston 7 by increasing the flow rate of the oil in chamber 5a when piston 7 comes out more the flow rate of the oil in chamber 5a when piston 7 is pushed back.

The springs are composed of a first spring 10 that is disposed in an expansion hole 5b, which is coaxially expanded and formed in front of chamber 5a of housing 5, and compressed when piston 7 is pushed, and a second spring 11 that is disposed in chamber 5a of housing 5 and compressed when piston 7 is pushed.

Further, the variable damper is composed of a piston flange 12 that coaxially expands at one end of piston 7 in chamber 5a of housing 5 and has a flow channel 12d where the oil passes, and an elastic cup 13 that is fitted around piston flange 12 to discharge the oil to the front while being compressed by pressure of the oil behind piston flange 12 when piston 7 passes through chamber 5a.

Piston flange 12 has a front flange 12a that coaxially expands with piston 7 at one end of piston 7 and a rear flange 12b that is coaxially formed at a distance behind front flange 12a and has a larger diameter than front flange 12a. The diameter of rear flange 12b is provided with a tolerance to be able to smoothly move forward/backward in chamber 5a, such as a common piston in a cylinder.

The portion between front flange 12a and rear flange 12b forms a cup seat 12c where cup 13 is fitted and the diameter of cup seat 12c is larger than that of piston 7.

Further, piston flange 12 has a flow channel 12d to allow the oil in chamber 5a to flow behind piston flange 12 and flow channel 12d is formed from front flange 12a having the larger diameter than piston 7 to rear flange 12b through cup seat 12c.

A plurality of flow channels 12d are formed and preferably six flow channels are formed at regular intervals of 60°.

Further, cup 13 is made of rubber such that the front portion is in close contact with front flange 12a and the rear portion is in close contact with rear flange 12b and the inside of chamber 5a when being fitted on cup seat 12c of piston flange 12.

According to the electro pedal of the invention, pedal simulator 4 is achieved by the variable damper including piston 7 operating with operation rod 8 connected to pedal 1 and elastically supported by first and second springs 10, 11 having different elasticity, piston flange 12 having flow channel 12d, through which the oil passes, at the end of piston 7 elastically supported by second spring 11 in chamber 5a filled with the oil, and rubber cup 3 being in close contact with piston flange 12 and changing the flow rate of oil while being elastically deformed by the hydraulic pressure according to the flow direction of the oil, such that it achieves hysteresis characteristics showing pedal effort without difference, such as when hydraulic pressure is used, not only generating simple linear pedal effort and a damping force from a fixed damping coefficient in operation and return stroke of pedal 1.

Accordingly, pedal simulator 4 applied to the electro pedal of the invention, as shown in FIG. 1, includes piston 7 that is moved forward/backward by operation rod 8 fixed to the rear portion of pedal 1 with one end hinged by pedal member 2, piston flange 12 having flow channel 12d coaxially formed at one end of piston to increase the flow rate of the oil when piston 7 is drawn more than when pushed in chamber 5a of housing 5 where piston 7 is inserted, and rubber cup 13 fitted around piston flange 12.

Further, pedal simulator 4 is further provided with a pair of springs elastically supporting piston 7, in which the damping force of pedal 1 is provided by first spring 10 elastically supporting piston 7 at the outside of housing and compressed when piston 7 is pushed and second spring 11 elastically supporting one end of piston 7 in chamber 5a of housing 5 and compressed when piston 7 is pushed.

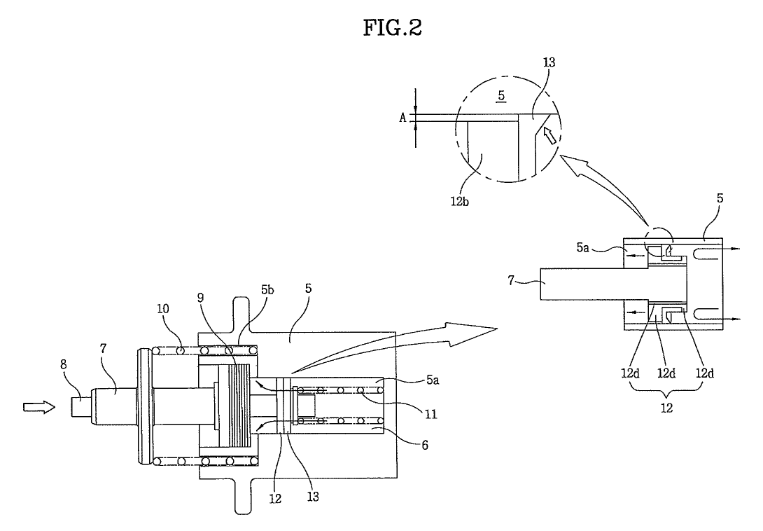

In characterizing hysteresis by pedal simulator 4, as shown in FIG. 2, as operation rod 8 and piston 7 are pushed by pedal 1 pressed, piston flange 12 with cup 13 at one end of piston 7 is pushed back in chamber 5a of housing 5.

Meanwhile, first spring 10 is compressed by the motion of piston 1 that is pushed, while second spring 11 is compressed by the motion of piston flange 12 in chamber 5a of housing 5.

First and second springs 10, 11 that are compressed by operation of pedal 1 make vibrations, but the operation of piston flange 12 that moves the oil in chamber 5a of housing as piston 7 moves reduces the vibrations of first and second springs 10, 11.

As piston flange 12 is pushed to chamber 5a together with piston 7 pushed, the oil is pressurized in front of piston flange 12 and the pressure is applied to piston flange 12, such that the oil flows behind piston flange 12 through flow channel 12d formed through piston flange 12. The oil flow in chamber 5a functions as a damper that reduces the vibration by first spring 10, particularly the vibration by the compression of second spring 11.

The oil in chamber 5a flows behind piston flange 12 only through flow channel 12d formed through piston flange 12, which is because the edge of cup 13 more contacts with the inside of chamber 5a while cup 13 on piston flange 12 is deformed by the pressure of the oil and the small gap A (exaggerated) between piston flange 12 and the inside of chamber 5a is completely closed.

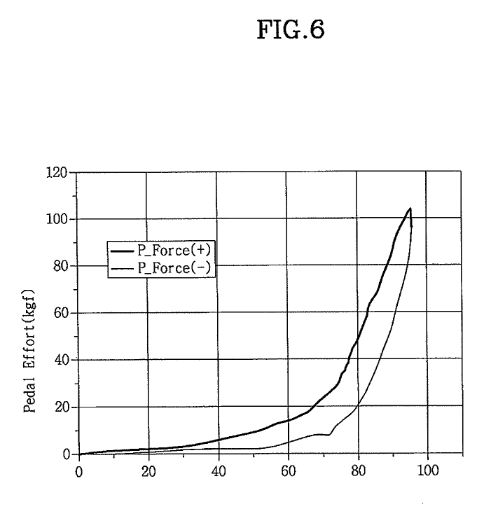

The pedal effort generated when pedal 1 is operated, as shown in FIG. 6, makes a hysteresis characteristic showing that damping is increased at a predetermined point in the pedal stroke.

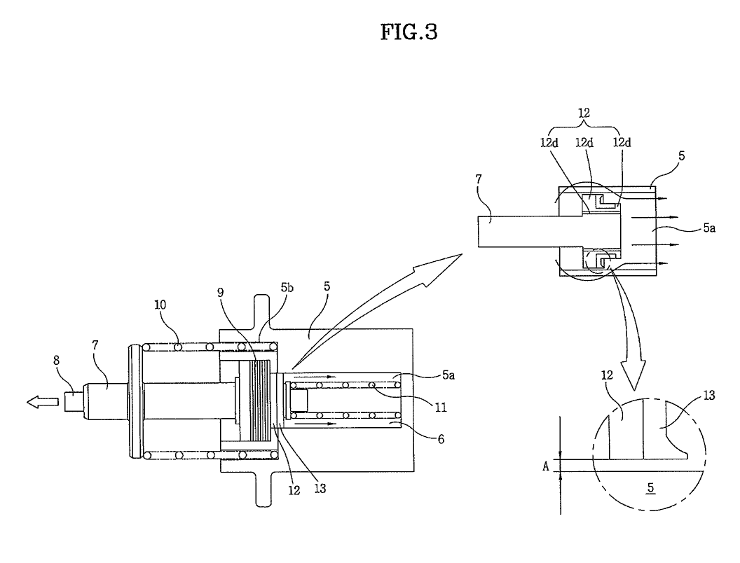

On the contrary, when first and second springs 10, 11 elastically return by releasing pedal 1 and piston 7 pushed out of chamber 5, as shown in FIG. 3, a hysteresis characteristic showing that the flow rate of oil in chamber 5a increases and reduction of return speed of pedal 1 is prevented is obtained.

As piston flange 12 is pushed out of chamber 5a together with piston 7, the oil behind piston flange 12 is pressurized by movement of piston flange 12 and applies pressure to piston flange 12, such that the pressure of the oil discharges the oil through flow channel 12d of piston flange 12 and increases the flow rate of the oil discharged by compressing cup 13.

That is, the oil pressure applied to piston flange 12 allows a portion of oil to be discharged through flow channel 12d and also presses the edge of cup 13 through the small gap A (exaggerated) between piston flange 12 and the inside of chamber 5a, such that the hydraulic pressure exerted in cup 13 compresses the edge of cup 13 and a gap is formed between the inside of chamber 5a and cup 13.

Cup 13 cannot block the oil flowing through the gap between piston flange 12 and the inside of chamber 5a by the compression of the edge of cup 13, such that the flow area of the oil increases and the oil behind piston flange 12 can be more quickly discharged. Therefore, the pressure of the oil prevents reduction of the moving-back speed of piston, such that, as shown in FIG. 6, a hysteresis characteristic that prevent the return speed of pedal 1 from being reduced is obtained.

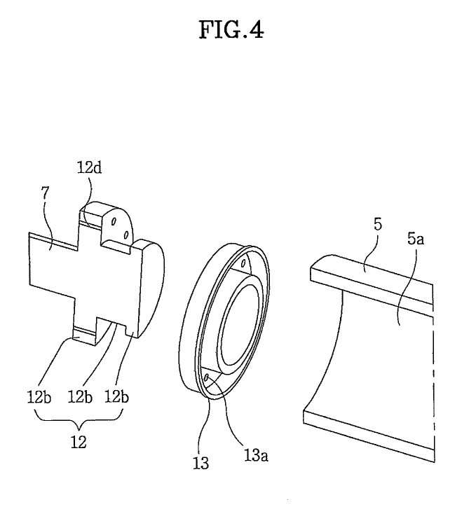

Pedal simulator 4 that operates such that the pedal effort has a hysteresis characteristic when pedal 1 is operated and released can have the same performance through various modifications, for example, as shown in FIG. 4, which can be achieved by changing the structure of the variable damper that changes the flow rate of oil in chamber 5a.

That is, the damping force is given to pedal 1 by changing the structures of piston flange 12 of the variable damper and rubber cup 13 fitted around piston flange 12, which can be achieved by forming an oil channel between cup 13 and piston flange 12 by forming a flow channel 13a along the edge of cup 13 to allow the oil to flow and flow channel 12d at the same position in piston flange 12 that is in close contact with cup 13.

Piston flange 12 has front flange 12a coaxially expanding with piston 7 at one end of piston 7 and rear flange 12b coaxially formed at a predetermined distance behind front flange 12a and having a larger diameter than front flange 12a. Further, flow channel 12d is formed through rear flange 12b to allow the oil in chamber 5a to flow behind piston flange 12.

Further, the front of cup 13 is close contact with front flange 12a when cup 13 is fitted on cup seat 12c of piston flange 12 and flow channel 13a is formed at the rear portion that is in close contact with rear flange 12b to correspond to flow channel 12d of rear flange 12.

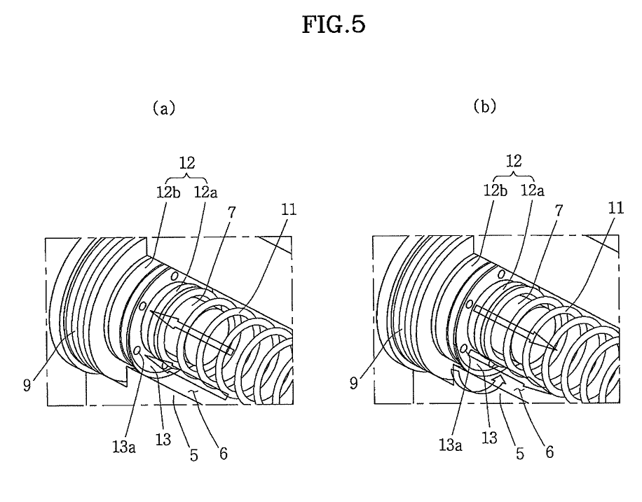

The variable damper providing a damping force when pedal 1 is operated has the same function, that is, when piston 12 is pushed out of chamber 5a of housing 5 by the operation of pedal 1, oil pressure is applied to piston flange 12 at one end of piston 12 and cup 13. The oil pressure, as shown in FIG. 5A, discharges the oil into flow channel 13a of cup 13, such that the oil flowing through cup 13 is discharged to the back of piston flange 12 through flow channel 12d formed through piston flange 12.

The movement of oil in chamber 5a to the back of the piston flange 12 reduces the vibrations of first spring 10 and second spring 11 that are compressed, which allows the pedal effort generated when pedal 1 is operated to achieve a hysteresis characteristic in which damping increases at a predetermined point in the pedal stroke.

The edge of cup 13 fitted around piston flange 12 that is pushed to chamber 5a more contacts with the inside of chamber 5a by the pressure of oil, such that the oil can be discharged only through flow channels 13a, 12d.

On the contrary, in addition to being discharged through flow channels 13a, 12d formed through piston flange 12 and cup 13 when pedal 1 is released, the edge of cup 13 is compressed by oil pressure behind piston flange 12, such that the flow area of the oil is increase to allow the oil to flows out between piston flange 12 and the inside of chamber 5a. Accordingly, as shown in FIG. 6, a hysteresis characteristic that prevents the return speed of pedal 1 from being reduced is also achieved.

What is claimed is:

1. A hysteresis characterizing typed electro pedal device comprising:
a pedal that is hinged at one end by a pedal member to be stamped by a driver; and
a pedal simulator that changes a damping force by operation and return stroke of the pedal by allowing oil filled in a chamber to flow backward through a piston flange formed at one end of a piston connected to the pedal when the piston is pushed in the chamber of a housing by operation of the pedal, and by discharging the oil through the piston flange when the piston is pushed out of the chamber of the housing by return of the pedal and discharging the oil through a gap between a cup that is compressed by oil pressure and the inside of the chamber.

2. The hysteresis characterizing typed electro pedal device as defined in claim 1, the simulator includes:
the housing that has the chamber receiving the oil, which is liquid filler, therein, and is attached to a car body behind the pedal;
the piston that moves forward/backward in the chamber by an operation rod fixed to the pedal;
a sealing member that maintains airtightness by closing an inlet of the chamber;
a pair of springs that generates pedal effort while being compressed when the piston is pushed back; and
a variable damper that changes the damping force according to the movement direction of the piston by increasing the flow rate of the oil in the chamber when the piston comes out more than the flow rate of the oil in the chamber when the piston is pushed back.

3. The hysteresis characterizing typed electro pedal device as defined in claim 2, wherein the springs includes a first spring that is disposed in an expansion hole, which is coaxially expanded and formed in front of the chamber of the housing, and compressed when the piston is pushed, and
a second spring that is disposed in the chamber of the housing and compressed when the piston is pushed.

4. The hysteresis characterizing typed electro pedal device as defined in claim 2, wherein the variable damper includes the piston flange that coaxially expands at one end of the piston in the chamber of the housing and has a flow channel where the oil passes, and
an elastic cup that is fitted around the piston flange to discharge the oil to the front while being compressed by pressure of the oil behind the piston flange when the piston passes through the chamber.

5. The hysteresis characterizing typed electro pedal device as defined in claim 4, wherein the piston flange has a front flange that coaxially expands with piston at one end of the piston and a rear flange that is coaxially formed at a distance behind the front flange and has a larger diameter than the front flange, and a cup seat having a larger diameter than the piston is formed between the front flange and the rear flange.

6. The hysteresis characterizing typed electro pedal device as defined in claim 5, a flow channel is formed from the front flange having the larger diameter than the piston to the rear flange through the cup seat.

7. The hysteresis characterizing typed electro pedal device as defined in claim 6, wherein a plurality of the flow channels are formed.

8. The hysteresis characterizing typed electro pedal device as defined in claim 4, wherein the cup has a diameter such that the front portion is in close contact with the front flange and the rear portion is in close contact with the rear flange and the inside of chamber, when being fitted on the cup seat of the piston flange.

9. The hysteresis characterizing typed electro pedal device as defined in claim 2, wherein the variable damper includes the piston flange that coaxially expands at one end of the piston disposed in the chamber of the housing and has a flow channel where the oil passes, at a position of which the diameter is larger than the diameter of the piston, and
the rubber cup that has a flow channel corresponding to the flow channel of the piston flange when being fitted around the piston flange.
